(19) United States
(12) Patent Application Publication
(10) Pub. No.: US 2007/0000884 A1
(43) Pub. Date: Jan. 4, 2007

(54) Pattern ablation using laser patterning

(76) Inventor: Islam A. Salama, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/172,677

(22) Filed: Jun. 30, 2005

(51) Int. Cl. B23K 26/36

(52) U.S. Cl. 219/121.68; 219/121.69

(57) ABSTRACT

An embodiment of the present invention is a technique to ablate patterns using laser patterning. A mask structure having features corresponding to first and second patterns receives an incident laser beam at a wavelength. A substrate panel is irradiated by the incident laser beam through the mask structure to have the first and second patterns ablated to first and second depths, respectively, such that a difference between the first and second depths is compensated according to an absorptivity of the mask structure. Hence, the first and the second patterns are ablated simultaneously.

### BACKGROUND

1. Field of the Invention

Embodiments of the invention relate to the field of electronic fabrication, and more specifically, to laser patterning.

2. Description of Related Art

Laser projection patterning (LPP) technique has been developed to create high resolution circuits in both thin and thick film metallic layers in high density packaging. LPP provides many advantages over the process on record (POR) substrate process such as high resolution, elimination of the multisteps lithographic process, improved alignment capabilities, and reduce/or eliminate de-smearing effects. LPP may be used in ablation of vias, traces, shapes, planes and pads.

However, the use of LPP or other laser patterning techniques in ablation of certain patterns such as vias, traces, and pads is still not efficient. To create vias and traces, two independent phases are needed. The process has low throughput due to increased processing time. In addition, the effect of via-to-pad and pad-to-via alignment may be compounded.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating an ablation unit according to one embodiment of the invention.

FIG. 3 is a diagram illustrating laser ablation characteristics according to one embodiment of the invention.

FIG. 4 is a flowchart illustrating a process to simultaneously ablate multiple patterns having different ablation depths according to one embodiment of the invention.

FIG. 5 is a diagram illustrating a stacked pattern structure according to one embodiment of the invention.

FIG. 6 is a flowchart illustrating a process to create a stacked pattern structure according to one embodiment of the invention.

### DESCRIPTION

An embodiment of the present invention is a technique to ablate patterns using laser patterning. A mask structure having features corresponding to first and second patterns receives an incident laser beam at a wavelength. A substrate panel is irradiated by the incident laser beam through the mask structure to have the first and second patterns ablated to first and second depths, respectively, such that a difference between the first and second depths is compensated according to an absorptivity of the mask structure.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

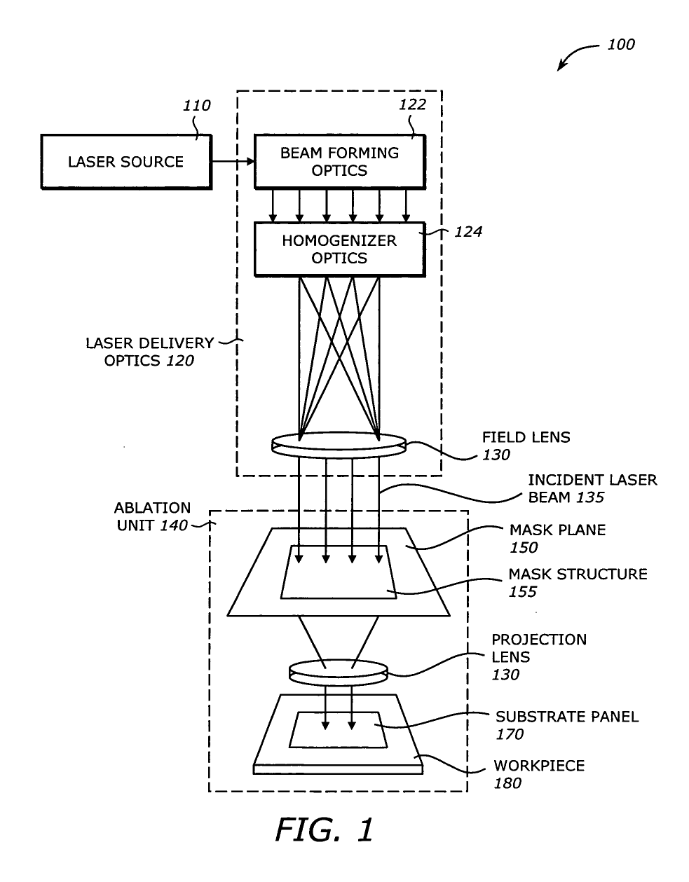

FIG. 1 is a diagram illustrating a system 100 in which one embodiment of the invention may be practiced. The system 100 includes a laser source 110, a laser delivery optics 120, and an ablation unit 140. Note that the system 100 may include more or less than these components depending on the particular system configuration and set-up.

The laser source 110 may be any suitable source that generates laser beams. Examples of the laser source 110 include Nd:YAG laser tool and, pulsed ultra-violet (UV) excimer laser. The wavelength may be any suitable wavelength for the application, such as Neodymium-doped Yttrium Aluminum Garnet (Nd:YAG, 1064 nm), Xenon Fluoride (XeF, 351 nm), Xenon Cloride (XeCl, 308 nm), Xenon Bromide (XeBr, 282 nm), Krypton Fluoride (KrF, 248 nm), Argon Fluoride (ArF, 193 nm), and Fluoride Dimer (F2, 157 nm).

The laser delivery optics 120 may include a beam forming optics 122, a homogenizer optics 124, and a field lens 130. The beam forming optics 122 may include optical units such as lenses, mirrors to shape, form, and direct the laser beam. The homogenizer optics 124 may convert the non-uniform laser beam into homogeneous beams with high (e.g., 95%) uniformity. The field lens 130 may distribute an incident laser beam 135 to the ablation unit 140.

The ablation unit 140 may include a mask plane 150, a projection lens 160, and a work piece 180. The mask plane 150 may contain a mask structure 155 to receive the incident laser beam 135. The mask structure 155 may contain features that correspond to patterns to be ablated on a substrate panel 170 on the work piece 180. The projection lens 160 may project the laser beam through the mask structure 155 onto the-substrate panel in order to achieve the required fluence 170. The substrate panel 170 contains the patterns to be ablated by the laser beam. The work piece 180 may operate with a step-and-repeat or synchronized motion mechanism (not shown) to move the panel 170 during the ablation.

One embodiment of the invention is a technique to ablate multiple patterns at different ablation depths simultaneously using the same number of pulses, the same pulse width, and the same laser beam power. Another embodiment is a technique to create stacked patterns having multiple layers. The techniques provide efficient ablation process. The laser techniques may include laser projection patterning (LPP) and laser-assisted metallization patterning (LAMP) techniques.

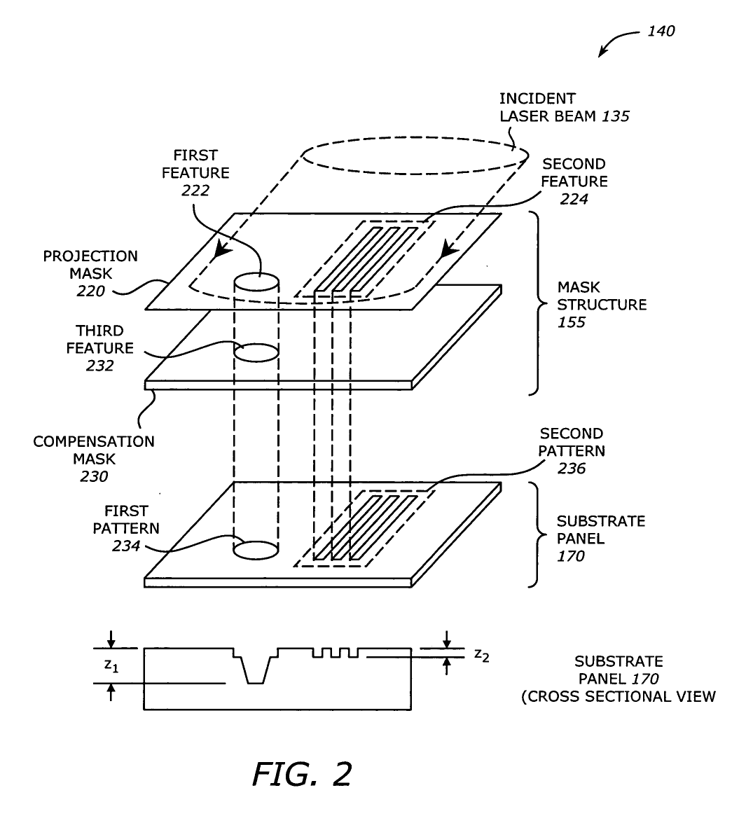

FIG. 2 is a diagram illustrating an ablation unit 140 according to one embodiment of the invention. For clarity, the projection lens 160, the mask plane 150, and the work piece 180 are not shown. The ablation unit 140 includes the mask structure 155 and the substrate panel 170.

The mask structure 155 may have features corresponding to first and second patterns to be ablated on the substrate panel 170. In one embodiment, the first pattern may be a via and the second pattern may be a trace or a collection of traces. As is known by one skilled in the art, any other types of patterns may also be used. These two patterns typically have different ablation depths. Traditional ablation techniques using LPP ablate patterns with different depths in multiple (e.g., two) stages, resulting in low throughput, alignment problems, etc. The technique in one embodiment of the invention allows ablation of these patterns at the same time, leading to high throughout and eliminating alignments issues. The mask structure 155 may include a projection mask 220 and a compensation mask 230. The projection mask 220 may contain first and second features corresponding to the first and second patterns. The compensation mask 230 may be optically coupled to the projection mask 220 according to the geometry of the laser system and the optics. It may be placed behind or ahead of the projection mask 220 with respect to the incident laser beam 135. In other words, the laser beam 135 may go through the projection mask 220 before or after the compensation mask 230. The compensation mask 230 contains a third feature corresponding to the first pattern. The third feature may be aligned with the first feature. The compensation mask 230 has an absorptivity to partially absorb the incident laser beam 135 at the wavelength of operation.

The substrate panel 170 may be irradiated by the incident laser beam 135 through the mask structure 155 to have the first and second patterns ablated to a first depth Z₁ and a second depth Z₂, respectively, such that a difference between the first and second depths Z₁ and Z₂ may be compensated according to the absorptivity of the mask structure 155. A cross-sectional view of the substrate panel 170 shows the ablation depths Z₁ and Z₂ of the two patterns. The substrate panel 170 may be irradiated with a first fluence at a first location corresponding to the first pattern and a second fluence at a second location corresponding to the second pattern. In one embodiment, the first fluence may be greater than the second fluence.

The material for the compensation mask 230 may be selected to have a suitable absorptivity. The absorptivity is determined by experiment for a material type for the compensation mask 230 such that the time to ablate the first pattern to the first depth Z₁ may be approximately equal to the time to ablate the second pattern to the second depth Z₂. This property may be derived according to the ablation characteristics of the LPP as will be illustrated in the following.

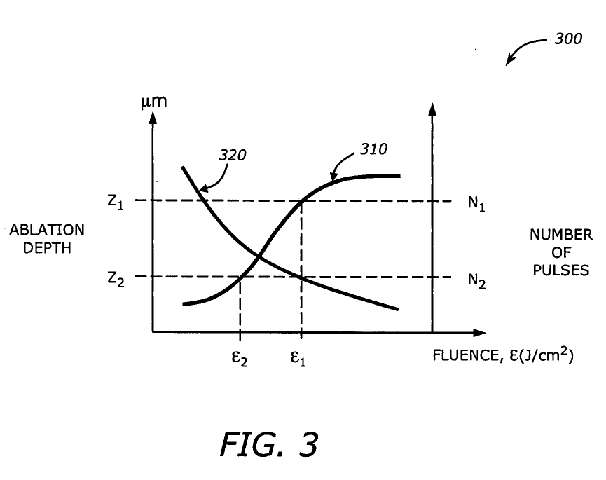

FIG. 3 is a diagram illustrating laser ablation characteristics according to one embodiment of the invention. The laser ablation characteristics 300 may include a curve 310 and a curve 320. The vertical axes include the ablation depth in μm and the number of pulses. The horizontal axis shows the fluence in Joules per cm² (J/cm²).

The curve 310 shows the ablation depth as a function of fluence. The curve 320 shows the number of pulses as a function of the fluence. To achieve simultaneous ablation of vias and traces, the same laser equipment set-up may be used. This means that the ablation may be performed for both vias and traces using the same number of pulses N with the same pulse width and the same output power of the laser. In order to do so, the absorptivity of the compensation mask may be determined to choose a suitable material for the compensation mask. This absorptivity A may be chosen such that the following boundary conditions are met.

Let: Z₁ and Z₂ be the via depth and the trace depth, respectively.
ε₁ and ε₂ be the total fluences to ablate the vias and the traces.
τ be the pulse width.

Since Z₁>Z₂, the total fluence ε₁ needed to ablate the vias is larger than the total fluence ε₂ needed to ablate the traces. In other words,
ε₁−ε₂=Aε₁ (1)

To perform simultaneous ablation of vias and traces, the time needed to ablate the vias to the depth is equal to or approximately equal to the time needed to ablate the traces to the depth. Or:
t=Nτ (2)

The values of ε₁ and ε₂ may be found experimentally from separate via and trace ablations.
ε₁=(1/area)* Integral of power P(t) over time (3)
ε₂=(1-A)*(1/area)*Integral of power P(t) over time (4)

In equations (2), (3), and (4), N, τ, and P(t) may be determined by the characteristics of the selected laser equipment. Solving equations (1), (3), (4) for a given material may provide the value of A.

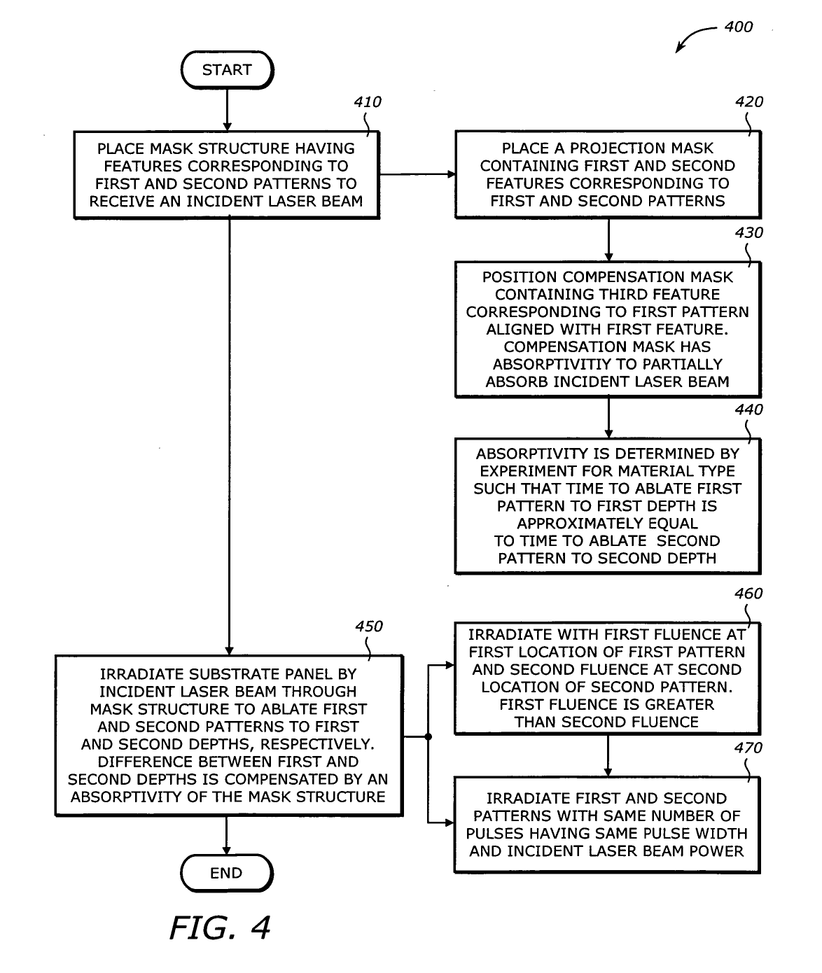

FIG. 4 is a flowchart illustrating a process 400 to simultaneously ablate multiple patterns having different ablation depths according to one embodiment of the invention.

Upon START, the process 400 places a mask structure having features corresponding to the first and second patterns (Block 410). The mask structure receives an incident laser beam. The process 400 performs this operation by placing a projection mask that contains the first and second features corresponding to the first and second patterns, respectively (Block 420). Then, the process 400 positions a compensation mask to be optically coupled to the projection mask (Block 430). The compensation mask contains a third feature that corresponds to the first feature and is aligned with the first feature. The compensation mask has an absorptivity to partially absorb the incident laser beam. The absorptivity may be determined by experiment for the material type for the compensation mask such that the time to ablate the first pattern to the first depth is approximately equal to the time to ablate the second pattern to the second depth (Block 440).

Next, the process 400 irradiates a substrate panel by the incident laser beam through the mask structure to ablate the first and second patterns to first and second depths, respectively (Block 450), and is then terminated. The difference between the first and second depths is compensated by the absorptivity of the compensation mask. The process 400 performs this operation by at least one of the following operations. In one operation, the process 400 irradiates with a first fluence at a first location of the first pattern and a second fluence at a second location of the second pattern (Block 460). The first fluence is greater than the second fluence so that the first depth is larger than the second depth. This is because the second fluence has been reduced by the absorbance of the compensation mask. In another operation, the process 400 irradiates the first and second patterns with the same number of pulses having the same width and with the same laser power (Block 470).

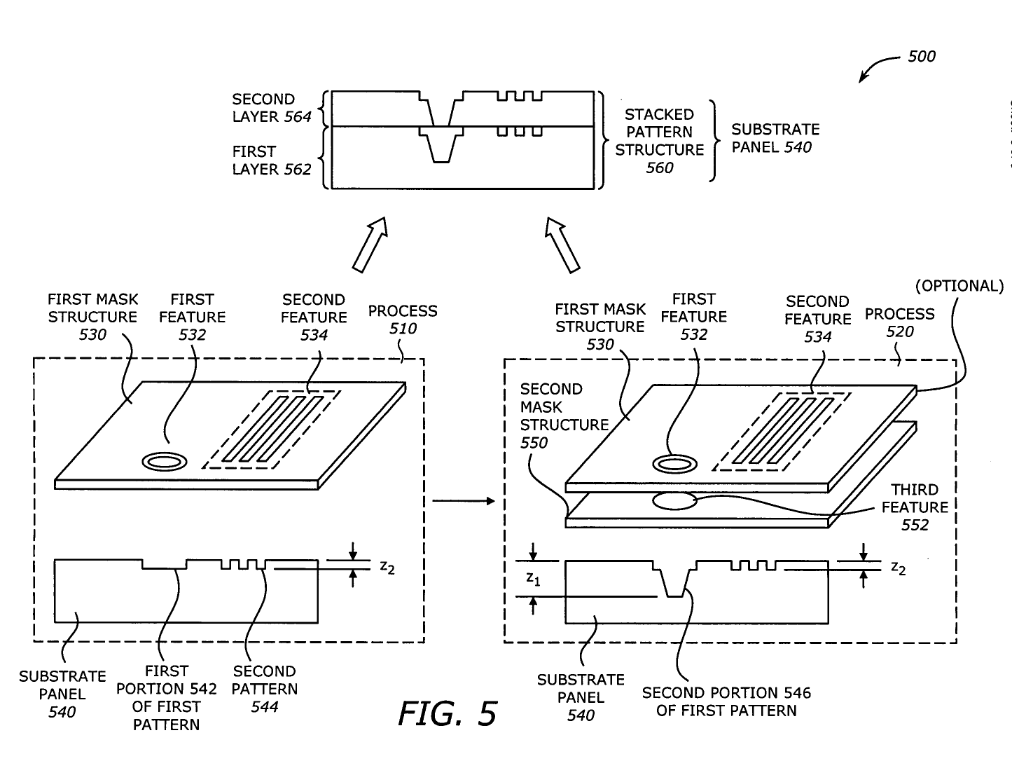

FIG. 5 is a diagram illustrating a stacked pattern structure 500 according to one embodiment of the invention. The stacked pattern structure 500 includes a substrate panel 540 having a stacked pattern structure 560.

The stacked pattern structure 560 may include multiple layers stacking on each other. For illustrative purposes, only two layers are shown: a first layer 562 and a second layer 564. Each of the layers may contain two patterns created by two processes 510 and 520. The processes 510 and 520 may be repeated to create the stacked layers 562 and 564.

In the process 510, a first mask structure 530 may be placed to receive an incident laser beam in the system shown in FIG. 1. The first mask structure 530 may contain a first feature 532 and a second feature 534 corresponding, respectively, to a first portion 542 of a first pattern and a second pattern 544 to be ablated in the substrate panel 540. For example, the first pattern 542 may be a via structure having a pad and a via and the second pattern 544 may be a trace or a collection of traces. The substrate panel 540 may be irradiated by the incident laser beam to ablate the first portion 542 of the first pattern and the second pattern 544. After this irradiation, the first portion 542 and the second pattern may have the same ablation depths.

In the process 520, the first mask structure 530 may be replaced by a second mask structure 550. Alternatively, the first mask structure 530 may be retained and a second mask structure 550 may be inserted so that both mask structures may be used at the same time in a similar manner as the mask structure 155 (shown in FIG. 2). The second mask structure 550 may contain a third feature 552 that corresponds to the second portion 546 of the first pattern. The third feature 552 may be aligned with the first feature, i.e., the second mask structure 550 may be positioned such that the third feature 552 occupies at the same location as the first feature 532 in the process 510. The substrate panel 540 may then be irradiated by the incident laser beam to ablate the second portion of the first pattern. After this operation, the first pattern may be ablated to have a depth Z₁ which may be deeper than the depth Z₂ of the second pattern 544.

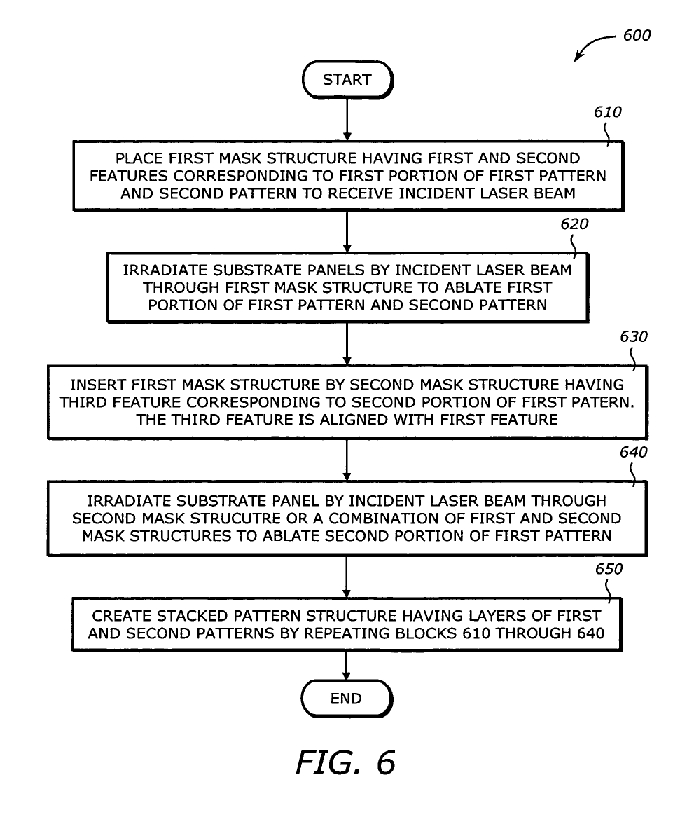

FIG. 6 is a flowchart illustrating a process 600 to create a stacked pattern structure according to one embodiment of the invention.

Upon START, the process 600 places a first mask structure having first and second features corresponding to a first portion of a first pattern and a second pattern (Block 610). In one embodiment, the first feature may correspond to a pad of a via structure and the second feature may correspond to a trace or a collection of traces. The first mask structure receives an incident laser beam. Then, the process 600 irradiates a substrate panel by the incident laser beam through the first mask structure to ablate the first and second patterns (Block 620). The first portion of the first pattern and the second pattern after this operation may have the same depths. Next, the process 600 replaces the first mask structure by, or inserts, a second mask structure having a third feature corresponding to a second portion of the first pattern (Block 630). For example, the third feature may correspond to a via of a via structure having the pad provided in Block 620. The third feature is aligned with the first feature. Then, the process 600 irradiates the substrate panel by the incident laser beam through the second mask structure, or the combination of both the first and second mask structures to ablate the second portion of the first pattern (Block 640). The first pattern and the second pattern are ablated in the same layer. After this operation, the first pattern may have a depth different than the depth of the second pattern due to the additional ablation of the second portion of the first pattern.

Next, the process 600 creates a stacked pattern structure having multiple (e.g., two) layers (Block 650) and is then terminated. Each layer contains the first and second patterns. The process 600 may perform this operation by repeating the operations in Blocks 610 through 650 for the next layer.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. An apparatus comprising:
a mask structure having features corresponding to first and second patterns, the mask structure receiving an incident laser beam at a wavelength; and
a substrate panel being irradiated by the incident laser beam through the mask structure to have the first and second patterns ablated to first and second depths, respectively, such that a difference between the first and second depths is compensated according to an absorptivity of the mask structure.

2. The apparatus of claim 1 wherein the mask structure comprises:
a projection mask containing first and second features corresponding to the first and second patterns; and
a compensation mask optically coupled to the projection mask and containing a third feature corresponding to the first pattern aligned with the first feature, the compensation mask having the absorptivity to partially absorb the incident laser beam at the wavelength.

3. The apparatus of claim 1 wherein the substrate panel is irradiated with a first fluence at a first location corresponding to the first pattern and a second fluence at a second location corresponding to the second pattern, the first fluence being greater than the second fluence.

4. The apparatus of claim 1 wherein the first and second patterns are ablated with same number of pulses having same pulse width and same laser beam power.

5. The apparatus of claim 2 wherein the absorptivity is determined by experiment for a material type for the compensation mask such that time to ablate the first pattern to the first depth is approximately equal to time to ablate the second pattern to the second depth.

6. The apparatus of claim 2 wherein the first pattern is a via having a via depth and the second pattern is a trace having a trace depth.

7. A method comprising:
placing a mask structure having features corresponding to first and second patterns to receive an incident laser beam;
irradiating a substrate panel by the incident laser beam through the mask structure to ablate the first and second patterns to first and second depths, respectively, such that a difference between the first and second depths is compensated according to an absorptivity of the mask structure.

8. The method of claim 7 wherein placing the mask structure comprises:
placing a projection mask containing first and second features corresponding to the first and second patterns; and
positioning a compensation mask to be optically coupled with the projection mask, the compensation mask containing a third feature corresponding to the first pattern aligned with the first feature, the compensation mask having the absorptivity to partially absorb the incident laser beam at the wavelength.

9. The method of claim 7 wherein irradiating comprises irradiating the substrate panel with a first fluence at a first location corresponding to the first pattern and a second fluence at a second location corresponding to the second pattern, the first fluence being greater than the second fluence.

10. The method or claim 7 wherein irradiating comprises irradiating the first and second patterns with same number of pulses having same pulse width and same laser beam power.

11. The method of claim 8 wherein positioning the compensation mask comprised positioning the compensation mask having the absorptivity determined by experiment for a material type for the compensation mask such that time to ablate the first pattern to the first depth is approximately equal to time to ablate the second pattern to the second depth.

12. The method or claim 2 wherein the first pattern is a via having a via depth and the second pattern is a trace having a trace depth.

13. A method comprising:
(a) placing a first mask structure having first and second features corresponding to a first portion of a first pattern and a second patterns, respectively, the first mask structure receiving an incident laser beam;
(b) irradiating a substrate panel by the incident laser beam through the first mask structure to ablate the first portion of the first pattern and the second pattern;
(c) inserting a second mask structure having a third feature corresponding to a second portion of the first pattern, the third feature being aligned with the first feature; and
(d) irradiating the substrate panel by the incident laser beam through the second mask structure or a combination of the first and second mask structures to ablate the second portion of the first pattern.

14. The method of claim 13 further comprising:
creating a stacked pattern structure having layers of the first and second patterns.

15. The method of claim 13 wherein creating the stacked pattern structure comprises:
repeating (a) to (d).

16. The method of claim 13 wherein the first feature corresponds to a pad, the second feature corresponds to a trace, and the third feature corresponds to a via underneath the pad.

17. A system comprising:
a laser source to emit an incident laser beam;
a delivery optics optically coupled to the laser source to deliver the incident laser beam; and
an ablation unit coupled to the delivery optics to ablate first and second patterns, the ablation unit comprising:
a mask structure having features corresponding to first and second patterns, the mask structure receiving an incident laser beam at a wavelength, and
a substrate panel being irradiated by the incident laser beam through the mask structure to have the first and second patterns ablated to first and second depths, respectively, such that a difference between the first and second depths is compensated according to an absorptivity of the mask structure.

18. The system of claim 17 wherein the mask structure comprises:
a projection mask containing first and second features corresponding to the first and second patterns; and
a compensation mask optically coupled to the projection mask and containing a third feature corresponding to the first pattern aligned with the first feature, the compensation mask having the absorptivity to partially absorb the incident laser beam at the wavelength.

19. The system of claim 17 wherein the substrate panel is irradiated with a first fluence at a first location corresponding to the first pattern and a second fluence at a second location corresponding to the second pattern, the first fluence being greater than the second fluence.

20. The system of claim 17 wherein the first and second patterns are ablated with same number of pulses having same pulse width and same laser beam power.
